(19) United States
(12) Patent Application Publication
(10) Pub. No.: US 2016/0150245 A1
(43) Pub. Date: May 26, 2016

(54) SYSTEM AND A METHOD FOR VIDEO ENCODING

(71) Applicant: POLITECHNIKA POZNANSKA, Poznan (PL)

(72) Inventors: Marek Domanski, Poznan (PL); Tomasz Grajek, Poznan (PL); Damian Karwowski, Poznan (PL); Krzysztof Klimaszewski, Murowana Goslina (PL); Olgierd Stankiewicz, Poznan (PL); Jakub Stankowski, Poznan (PL); Krzysztof Wegner, Murowana Goslina (PL)

(21) Appl. No.: 14/578,435

(22) Filed: Dec. 21, 2014

(30) Foreign Application Priority Data
Nov. 26, 2014 (PL) PL410246

(51) Int. Cl. H04N 19/52; H04N 19/91; H04N 19/513

(52) U.S. Cl. CPC H04N 19/52; H04N 19/521; H04N 19/91

(57) ABSTRACT

A computer implemented method for encoding of input video data, the method comprising the steps of: denoising the input video data to obtain denoised data; encoding the denoised data; retrieving coding modes used during the encoding of the denoised data; and encoding the input video data using the retrieved coding modes.

### TECHNICAL FIELD

The present invention relates to a system and a method for video encoding. In particular, the present invention relates to improving coding efficiency.

### BACKGROUND

Transmission of video data has become more popular as network bandwidth has increased to handle the bandwidth required for video data having an acceptable quality level. Video data requires a high bandwidth, i.e., many bytes of information per second. Therefore, video compression or video coding technology reduces the bandwidth requirements prior to transmission of the video data. However, the compression of the video data may negatively impact the image quality when the compressed video data is decompressed for presentation. For example, block based video compression schemes, such as Moving Picture Experts Group (MPEG) coding standard, suffer from blocking artifacts which become visible at the boundaries between blocks of a frame of the video image.

In a typical video coding system, a video capture device captures image data. The image data is then compressed according to a compression standard through an encoder. The compressed image data is then transmitted over a network to a decoder. The decoder may include a post-processing block, which is configured to compensate for blocky artifacts. The decompressed image data that has been post-processed is then presented on a display monitor. Alternatively, placement of the processing block configured to compensate for blocky artifacts may be within encoder. Here, a DCT domain filter can be included within the encoder to reduce blocky artifacts introduced during compression operations. Thus, the post-processing block includes the capability to offset blocky artifacts, e.g., low pass filters applied to the spatial domain attempt to compensate for the artifacts introduced through the compression standard. However, one shortcoming with current post-processing steps is their computational complexity, which requires a large portion of the total computational power needed in the decoder, not to mention the dedication of compute cycles for post-processing functions. It should be appreciated that this type of power drain is unacceptably high for mobile terminals, i.e., battery enabled consumer electronics. The current in-loop filtering is not capable of effectively handling noise introduced into the encoder loop from the input device in addition to smoothing blocky artifacts. Furthermore, since the noise from the input device tends to be random, the motion tracker of the encoder is fooled into following noise rather than the actual signal. For example, the motion tracker may take a signal at time t and then finds a location where the difference is close to 0. Thereafter, the motion tracker outputs a motion vector and the difference. However, random noise causes the difference to become the difference between the signal and the noise rather than the difference between the true motion. Thus, if the motion vector is dominant, then everything becomes influenced by noise rather than the actual signal. As a result, there is a need to solve the problems of the prior art to provide a method and system for reducing input device generated noise from a video signal prior to the video signal being received by the encoder.

A U.S. Pat. No. 7,394,856 discloses a method for adaptively filtering a video signal prior to encoding to improve a codec's efficiency while simultaneously reducing the effects of noise present in the video signal being encoded. It provides a prefilter configured to adaptively apply a smoothing function to video data in addition to reducing noise generated from a device transmitting the video data.

It would be advantageous to further improve codec efficiency, by processing noise, but without actually altering the video data to be encoded.

### SUMMARY

There is presented a computer implemented method for encoding of input video data, the method comprising the steps of: denoising the input video data to obtain denoised data; encoding the denoised data; retrieving coding modes used during the encoding of the denoised data; and encoding the input video data using the retrieved coding modes.

Preferably, the coding modes are decision points outputs selected during encoding process, at which the encoder selects one of possible modes.

Preferably, the encoding is implemented using AVC (Advanced Video Coding) and the coding modes are: macroblock type and/or prediction type and/or motion vector.

Preferably, the encoding is implemented using HEVC (High Efficiency Video Coding) and the coding modes are: macroblock type and/or prediction type and/or motion vector and/or the applied division tree of TU (Transform Unit) and/or PU (Prediction Unit) units.

There is also presented a computing device program product for encoding of input video data using a computing device, the computing device program product comprising: a non-transitory computer readable medium; first programmatic instructions for denoising the input video data to obtain denoised data; second programmatic encoding the denoised data; third programmatic retrieving coding modes used during the encoding of the denoised data; and fourth programmatic encoding the input video data using the retrieved coding modes.

There is further presented a system for encoding input video data, the system comprising: a first encoder comprising a denoising block for denoising the input video data to obtain denoised data and encoding blocks for encoding the denoised data and outputting coding modes used during the encoding of the denoised data; and a second encoder comprising encoding blocks for encoding the input video data using the coding modes output from the first encoder and outputting entropy coded data.

There is also presented a video data encoder comprising: a data bus communicatively coupling components of the encoder; a video data input interface for receiving input video data; a memory; a controller; a video data output interface for outputting output video data; a noise filter; wherein the controller is configured to execute the following steps: receiving the input video data via the video data input interface; denoising, using the noise filter, the input video data to obtain denoised data; encoding the denoised data; retrieving coding modes used during the encoding of the denoised data; encoding the input video data using the retrieved coding modes to provide the output video data; and outputting the output video data via the video data output interface.

### BRIEF DESCRIPTION OF FIGURES

These and other objects of the invention presented herein are accomplished by providing a system and a method for video encoding. Further details and features of the present invention, its nature and various advantages will become more apparent from the following detailed description of the preferred embodiments shown in a drawing, in which:

FIG. 1 presents a diagram of the system for video encoding;

FIG. 2 presents a diagram of the method for video encoding;

FIG. 3 presents a diagram of two cooperating AVC encoders.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities.

Usually these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like.

Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computer's registers and memories into other data similarly represented as physical quantities within the memories or registers or other such information storage.

A computer-readable (storage) medium, such as referred to herein, typically may be non-transitory and/or comprise a non-transitory device. In this context, a non-transitory storage medium may include a device that may be tangible, meaning that the device has a concrete physical form, although the device may change its physical state. Thus, for example, non-transitory refers to a device remaining tangible despite a change in state.

### DESCRIPTION OF EMBODIMENTS

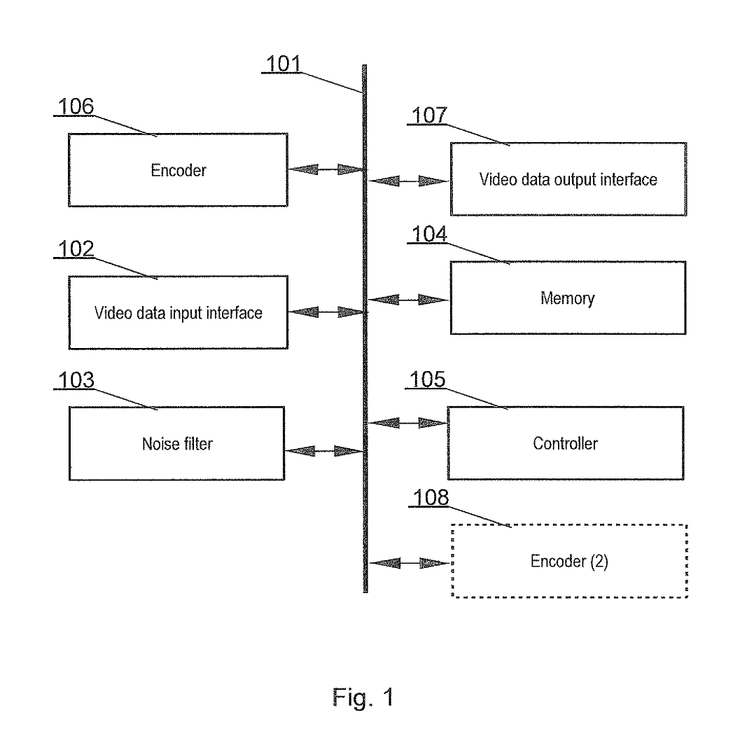

FIG. 1 presents a diagram of the system for encoding video, i.e. a video encoder. The system may be realized using dedicated components or custom made FPGA (Field Programmable Gate Array) or ASIC (Application Specific Integrated Circuit) circuits.

The system comprises a data bus 101 communicatively coupled to a memory 104. Additionally, other components of the system are communicatively coupled to the system bus 101 so that they may be managed by a controller 105. The memory 104 may store computer program or programs executed by a controller 105 in order to execute steps of the method for video encoding presented below. Input data may be fed to the system via a video data input interface 102, which may be a network interface such as the Ethernet, Wi-Fi, a data bus interface such as I2C, a wired interface such as USB, FireWire etc. A video data output interface 107 may be similar to the video data input interface or it may be the same interface when bidirectional data exchange is possible. The video data may comprise uncompressed images such as video frames or compressed images in case transcoding from one encoding format to another encoding format is required.

Due to the fact that video data often comprises noise, the system further comprises a noise filter 103 configured to denoise the input video data. Examples of filtering methods may be such as a linear smoothing filter, low pass filters such as FIR or IIR, anisotropic diffusion or nonlinear filters (e.g. median, bilateral filter).

The system further comprises at least one video data encoder 106 such as an AVC encoder (Advanced Video Coding) or HEVC encoder (High Efficiency Video Coding).

The present invention treats the encoder as a module performing a certain function, irrespective from its software or hardware implementation and the fact whether a plurality of encoders share resources. In case there is physically a single encoder (operating in an alternating manner on filtered and non-filtered image), the encoder would need to switch its context (the state of the encoder) between encoding of a filtered and non-filtered image.

In order to make the encoding more time efficient, a second optional encoder 108 may be provided in the system. The second encoder shall be of the same type as the first encoder, e.g. AVC or HEVC.

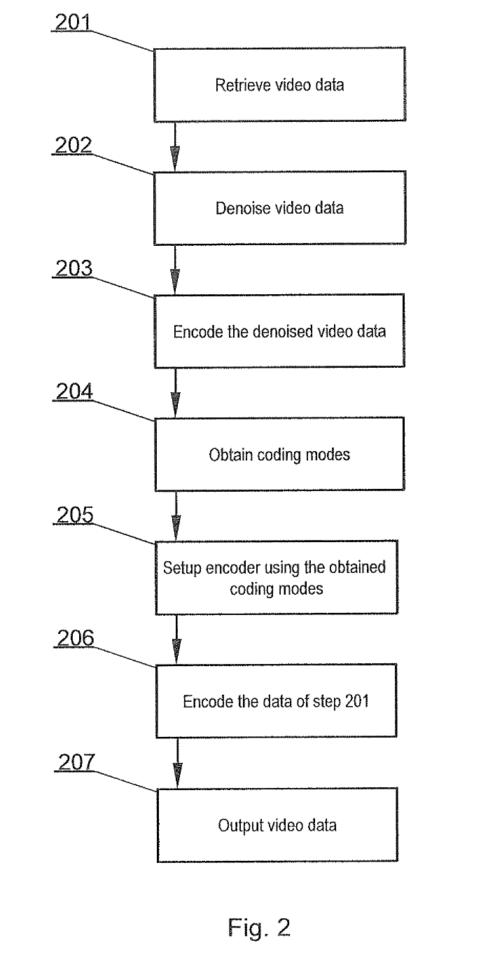

The aforementioned encoding setup allows to realize the following video input encoding method, shown in FIG. 2.

The method starts at step 201 from retrieving video data. Depending on the employed denoising type (spatial, temporal, spatial-temporal), the video data may comprise one or more video data frames.

Subsequently, at step 202, the received video data is subject to denoising in the noise filter 103 module. Next, at step 203, the denoised video data is encoded by the encoder 106. Further, at step 204, coding modes used during the encoding of step 203 are retrieved and preferably stored in the memory 104.

The coding modes are herein understood as decision points outputs selected during encoding process, at which an encoder may select one of possible modes (for example allowed by a coding standard). For example, in case of AVC encoding, the coding the modes may include: macroblock type (I/P/B), prediction type, motion vector. In case of HEVC coding, the modes may include: applied partitioning of picture into Coding Tree Units (CTUs), partitioning into Prediction Units (PUs) and Transform Units (TUs), prediction type in each PU, motion vector.

Coding Tree Unit (CTU) is the basic processing unit of the HEVC video standard and conceptually corresponds in structure to macroblock units that were used in several previous video standards.

Most of generic implementations of encoders (e.g. reference software for MPEG-AVC or HEVC) comprise a “trace” output providing a log of coding modes that have been applied by the encoders during processing of input data.

However in a typical, commercial implementation, the trace output is typically not available for reading coding modes. In order for such output to be available, it would be necessary to modify such a typical, commercial encoder implementation.

Apart from the aforementioned, the applied coding modes are always signaled in the encoded output data stream, which is a primary output of an encoder.

Subsequently, at step 205, there is executed setup of the encoder 106 using the obtained coding modes. Alternatively, the setup may be effected on the second optional encoder 108, so that the first encoder 106 may at the same process another video input data in order to increase encoding throughput.

The coding modes are used during encoding of a sequence. In particular, coding modes relevant for a given section of an image are applied at the time of encoding of this fragment. In this sense the coding modes are sequentially applied during the encoding process. However, there may be a case where a complete set of coding modes is provided to an encoder in advance for a complete picture or a plurality of pictures and its data are selectively applied when required.

At step 206, the same video data, as in step 201, are encoded i.e. the raw input not subject to denoising.

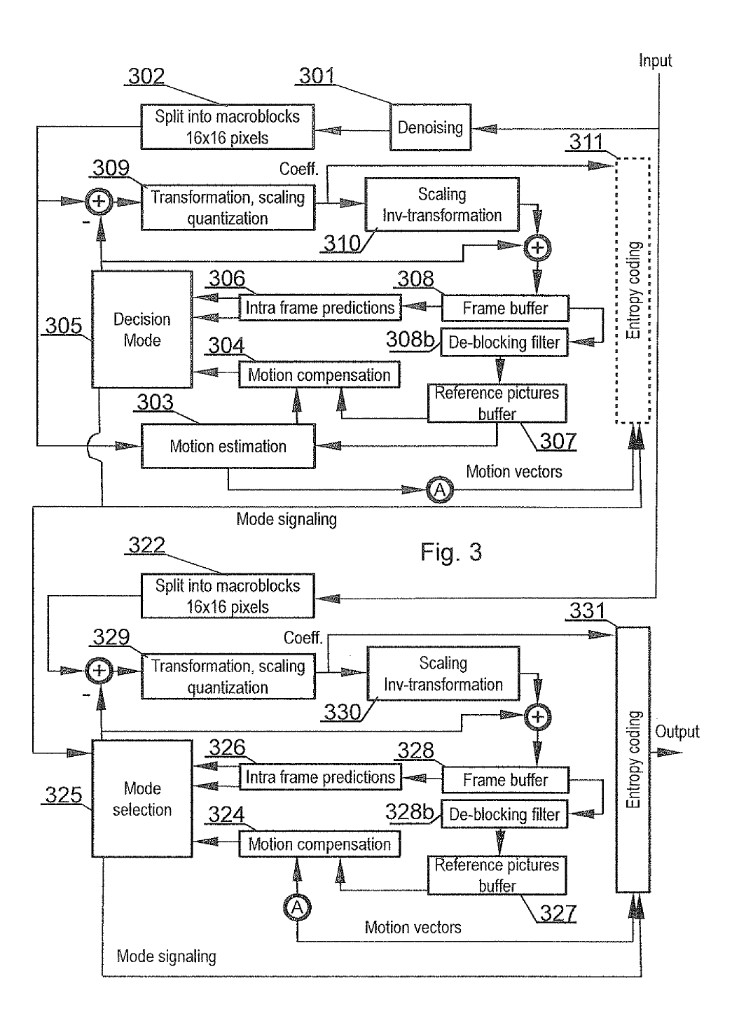

FIG. 3 presents a diagram of two AVC encoders cooperating according to presented method and system. The first encoder comprises elements 302-311 and the second encoder comprises elements 322-331. The encoders may comprise the same modules, however in a particular embodiment the entropy encoding module 311 of the first encoder may be omitted. The coding modes signaling of the first encoder is provided from its decision module 305 to the modes selection block 325 of the second encoder, while the motion estimation module 303 of the first encoder may be omitted in the second encoder because the motion vectors may be provided from the output of the motion estimation module 303 of the first encoder. The output of the entropy encoder 331 of the second encoder is the final processing output.

The input video is denoised in block 301 and the denoised images are partitioned in the first encoder in block 302, for example to macroblocks of 16×16 pixels.

In the second encoder, the input video is not denoised and the input images are partitioned in block 322, for example to macroblocks of 16×16 pixels.

After that, each macroblock is processed subsequently.

Further, with use of a prediction signal (which may be Intra or Inter, depending on decision in block 305, 325), a residual signal is generated by means of subtraction (− sign). This residual is transformed with a use of the Discrete Cosine Transform (DCT), scaled and quantized, in blocks 309, 329.

The results, in a form of quantized DOT coefficients, are entropy coded in blocks 311 (optionally) and 331. Those quantized DCT coefficients are also scaled and transformed back in blocks 310, 330, summed with the prediction signal, and used to form a reconstructed video signal. This video signal is stored in a reconstructed video frame buffer blocks 307, 327 after application of a de-blocking filters 308b, 328b and used as a source of predictions: Intra (block 306, 326) and Inter by means of a motion compensation block 304, 324 based on motion vectors found by a motion estimation block 303.

All tested prediction types are compared and based on that, the encoder decides, which one is to be used for encoding of the next macroblock.

Reference (A) on the drawing indicates a point at which motion vectors are transferred from block 303 to blocks 324, 331 and 311 (optionally, if block 311 is present). Reference (A) is introduced to improve clarity of the drawing.

One skilled in the art will recognize that an equivalent setup of two encoders as shown in FIG. 3 may be constructed for an HEVC encoder and encoders of other types.

Setting up encoding based on coding modes applied during encoding of a denoised video data input allows for (a) increasing compression while keeping desired quality, or (b) increasing quality while maintaining the same bandwidth. Further, the present invention allows for decreasing encoder's sensitivity to noise present in the input video data. Therefore, the invention provides a useful, concrete and tangible result and technical effect.

Due to the fact that a new video data encoder is presented herein, which applies a special encoding process, the machine or transformation test is fulfilled and the idea is not abstract.

It can be easily recognized, by one skilled in the art, that the aforementioned method for video encoding may be performed and/or controlled by one or more computer programs. Such computer programs are typically executed by utilizing the computing resources in a computing device. Applications are stored on a non-transitory medium. An example of a non-transitory medium is a non-volatile memory, for example a flash memory, while an example of a volatile memory is RAM. The computer instructions are executed by a processor. These memories are exemplary recording media for storing computer programs comprising computer-executable instructions performing all the steps of the computer-implemented method according the technical concept presented herein.

While the invention presented herein has been depicted, described, and has been defined with reference to particular preferred embodiments, such references and examples of implementation in the foregoing specification do not imply any limitation on the invention. It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification, but is only limited by the claims that follow.

We claim:

1. A computer implemented method for encoding of input video data, the method comprising the steps of:
denoising the input video data to obtain denoised data;
encoding the denoised data;
retrieving coding modes used during the encoding of the denoised data; and
encoding the input video data using the retrieved coding modes.

2. The method of claim 1 wherein the coding modes are decision points outputs selected during encoding process, at which the encoder selects one of possible modes.

3. The method of claim 2 wherein the encoding is implemented using AVC (Advanced Video Coding) and the coding modes are: macroblock type and/or prediction type and/or motion vector.

4. The method of claim 2 wherein the encoding is implemented using HEVC (High Efficiency Video Coding) and the coding modes are: macroblock type and/or prediction type and/or motion vector and/or the applied division tree of TU (Transform Unit) and/or PU (Prediction Unit) units.

5. A computing device program product for encoding of input video data using a computing device, the computing device program product comprising:
a non-transitory computer readable medium;
first programmatic instructions for denoising the input video data to obtain denoised data;
second programmatic encoding the denoised data;
third programmatic retrieving coding modes used during the encoding of the denoised data; and
fourth programmatic encoding the input video data using the retrieved coding modes.

6. A system for encoding input video data, the system comprising:
a first encoder comprising a denoising block for denoising the input video data to obtain denoised data and encoding blocks for encoding the denoised data and outputting coding modes used during the encoding of the denoised data; and
a second encoder comprising encoding blocks for encoding the input video data using the coding modes output from the first encoder and outputting entropy coded data.

7. A video data encoder comprising:
a data bus communicatively coupling components of the encoder;
a video data input interface for receiving input video data;
a memory;
a controller;
a video data output interface for outputting output video data;
a noise filter;
wherein the controller is configured to execute the following steps:
receiving the input video data via the video data input interface;
denoising, using the noise filter, the input video data to obtain denoised data;
encoding the denoised data;
retrieving coding modes used during the encoding of the denoised data;
encoding the input video data using the retrieved coding modes to provide the output video data; and
outputting the output video data via the video data output interface.
